(19) United States
(12) Patent Application Publication
(10) Pub. No.: US 2009/0001969 A1
(43) Pub. Date: Jan. 1, 2009

(54) SYSTEM AND METHOD FOR ELECTROMAGNETIC NAVIGATION OF A MAGNETIC FIELD GENERATING PROBE

(75) Inventor: Ertugrul Berkcan, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/771,097

(22) Filed: Jun. 29, 2007

(51) Int. Cl. G01B 7/004

(52) U.S. Cl. 324/207.16

(57) ABSTRACT

An electromagnetic navigation probe includes a structural component, a magnetic field generator coupled to the structural component for generating a magnetic field and an actuator for varying the magnetic field as a function of time and space such that a location of the probe in three dimensional space can be determined.

### BACKGROUND

Embodiments of the invention relate generally to a system and method for electromagnetic navigation of a magnetic field generating probe.

Electromagnetic navigation, also referred to as navigational electromagnetic tracking, is a method used to determine and track the position of an instrument such as a surgical probe during a procedure. By overlaying or superimposing the location of the probe on a previously or contemporaneously acquired electronic representation of an area of interest, such as a computed tomography scan, it is possible to track the location of the probe through the area of interest.

Electromagnetic tracking of the position and orientation of medical instruments during medical procedures can be used for a number of beneficial purposes. For example, such tracking can be used as a way to decrease patient exposure to x-ray radiation by decreasing the number of x-ray images required during a medical procedure in order to determine the position of a surgical instrument. Typically, an electromagnetic tracking system employs transmitters and receivers. The transmitter emits at least one signal at a frequency that is picked up by the receiver. The signals from the transmitter are received at the receiver and the tracking system calculates position and orientation information for the medical instrument with respect to the patient or with respect to a reference coordinate system. During a medical procedure, a medical practitioner may refer to the tracking system to determine the position and orientation of the medical instrument when the instrument is not within the practitioner's line of sight.

Conventional electromagnetic type navigation systems typically employ reference coils that are placed around an area of interest to provide the signals which are in turn detected by receivers on a probe. Often, probes are equipped at their tips with three sets of passive coil windings that are excited by the high frequency signals originating from the reference coils spaced apart from the probe. Although such conventional arrangements may be capable of providing a high degree of accuracy in detecting the location of the probe tip, the coils are highly sensitive to noise. Although such sensitivity to noise can be improved by increasing the time rate of change (i.e., frequency) of the magnetic field, vulnerabilities to metal due to eddy currents increase as the frequency of the magnetic field increases. The eddy currents in nearby conductive materials will distort the position readings from the tracking system.

### BRIEF DESCRIPTION

In accordance with one embodiment, an electromagnetic navigation probe includes: a structural component, a magnetic field generator coupled to the structural component for generating a magnetic field, and an actuator for varying the magnetic field as a function of time and space such that a location of the probe in three dimensional space can be determined.

In accordance with another embodiment, an electromagnetic navigation system includes an electromagnetic navigation probe for performing a procedure within an area of interest wherein the probe comprises a magnetic field generator and an actuator to induce a change in magnetic flux in a magnetic field generated by the magnetic field generator. The electromagnetic navigation system further includes a plurality of detectors spaced away from the probe to detect the magnetic field generated by the probe, and an analyzer to determine a location of the probe within three-dimensional space based at least in part upon the magnetic field.

In accordance with yet another embodiment, a method includes positioning an electromagnetic navigation probe within an area of interest, generating a magnetic field at the probe, detecting the magnetic field at a detector spaced apart from the probe, and determining the location of the probe within the area of interest based at least in part upon the detected magnetic field.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram illustrating an electromagnetic navigation system in accordance with one embodiment of the present invention;

FIG. 2 is a schematic diagram illustrating a magnetic dipole in accordance with one embodiment of the invention;

FIG. 3 is a schematic diagram illustrating one embodiment of the electromagnetic navigation probe of FIG. 1;

FIG. 4 is a schematic diagram illustrating a top-view and a side view of one embodiment of a MEMS device configured for use with the electromagnetic navigation probe of FIG. 1 and FIG. 3;

FIGS. 5-7 are schematic diagrams each illustrating alternative embodiments of a MEMS device 300 configured to generate a magnetic field in connection with the electromagnetic navigation probe 100 of FIG. 1 and FIG. 3;

FIG. 8 is a schematic diagram illustrating an example application 800 of the electromagnetic navigation system of FIG. 1; and

FIG. 9 is a block diagram illustrating an example operational flow for a method of determining a location of an electromagnetic navigation probe within an electromagnetic navigation system such as that illustrated in FIG. 8.

### DETAILED DESCRIPTION

In accordance with one or more embodiments of the present invention, a system and method for electromagnetic navigation of a magnetic field generating probe as well as embodiments of such probes are described herein. In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be open ended and synonymous unless otherwise indicated.

In accordance with one embodiment of the present invention, an electromagnetic navigation probe and associated electromagnetic navigation system and method are provided in which the electromagnetic navigation probe operates to generate a magnetic field, which in turn is detectable by one or more magnetic field sensors or detectors. In one embodiment, the electromagnetic navigation probe functions as an active field-emitting device that generates a low frequency magnetic field and is capable of providing a high level of resolution with very low sensitivity to metal objects.

In one embodiment, as will be described in further detail to follow, the electromagnetic navigation probe described herein includes an extremely small micro electromechanical system (hereinafter “MEMS”) that is used in the generation of the magnetic field. Presently, MEMS generally refer to micron-scale structures that for example can integrate a multiplicity of elements, e.g., mechanical elements, electromechanical elements, sensors, actuators, and electronics, on a common substrate through micro-fabrication technology. It is contemplated, however, that many techniques and structures presently available in MEMS devices will in just a few years be available via nanotechnology-based devices, e.g., structures that may be smaller than 100 nanometers in size. Accordingly, even though example embodiments described throughout this document may refer to MEMS-based devices, it is submitted that the inventive aspects of the present invention should be broadly construed and should not be limited to micron-sized devices.

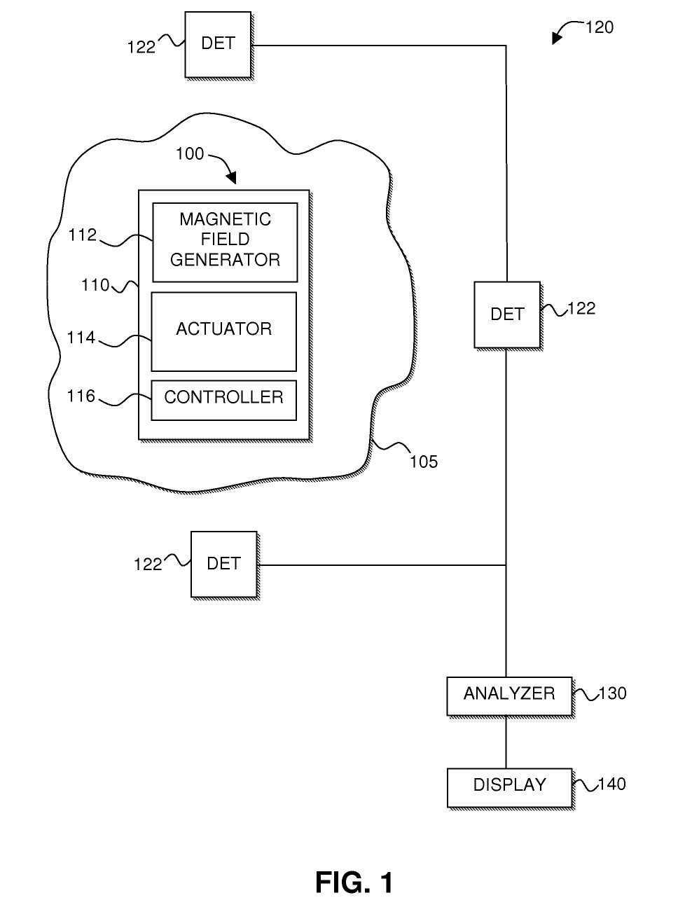

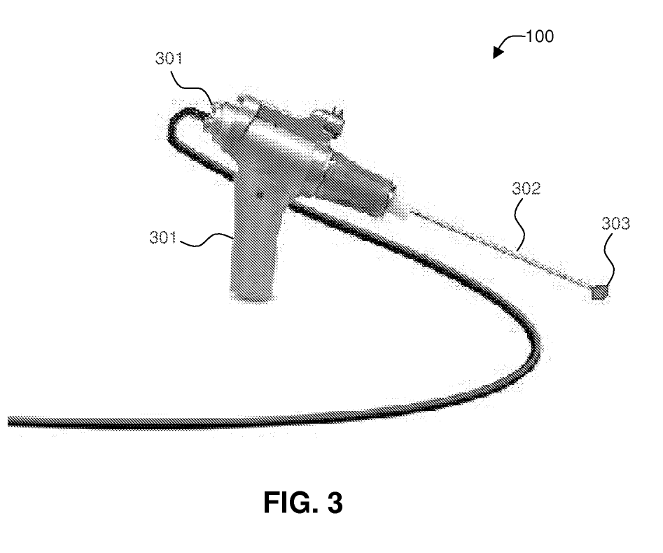

FIG. 1 is a schematic diagram illustrating an electromagnetic navigation system 120 in accordance with one embodiment of the present invention. As illustrated, an electromagnetic navigation probe 100 (described in further detail with respect to FIG. 3) may include a magnetic field generator 112, an actuator 114, and at least one structural component 110 coupled (directly or indirectly) to the magnetic field generator 112 and the actuator 114. In one embodiment, the magnetic field generator 112 acts to generate a magnetic field at the location of the probe, while the actuator 114 acts to vary the magnetic flux as a function of time and space to obtain an oscillating magnetic field such that the location of the probe in three-dimensional space can be determined. The electromagnetic navigation probe 100 may further include a controller 116 that is coupled to the actuator 114 to control the variations in the magnetic flux as a function of time and space. The controller 116 may be supported by the structural component 110 or may be physically separated from the structural component 110. Similarly, the controller 116 may share a common housing with the magnetic field generator 112, the actuator 114, and the structural component 110, or the controller 116 may be separately housed.

In accordance with one embodiment, the electromagnetic navigation probe 100 may be positioned and operated within an area of interest 105. The area of interest 105 may represent a wide variety of regions or articles and may vary in size and location depending upon the desired end use of the probe. For example, the electromagnetic navigation probe 100 may be used to perform a procedure such as a medical or surgical procedure in which the area of interest 105 may represent a patient or a specific anatomical region (e.g., head) of a patient. As such, the electromagnetic navigation probe 100 may represent e.g., a surgical probe, a catheter, an endoscope, a shunt, a drill guide, and an orthopedic implant instrument to name just a few exemplary devices. In addition to finding application in the medical fields, the electromagnetic navigation probe 100 may further be used for non-destructive testing or analysis where the area of interest 105 may represent an industrial item or device to be inspected or analyzed.

In one embodiment, a magnetic field generated by the electromagnetic navigation probe 100 is detected by field detectors 122 spaced apart from the probe. The field detectors 122 may represent any number of active or passive sensors equipped, designed or otherwise configured to detect aspects of the magnetic field generated by the electromagnetic navigation probe 100. More specifically, the field detectors 122 may be selected and positioned at a distance from the electromagnetic navigation probe 100 surrounding the area of interest 105 so as to be able to detect the magnetic field signals created by the probe and in particular, the MEMS device described herein. In one embodiment, field detectors 122 may be formed by an array of sensors. The sensor array may be a planar collection of sensors where each sensor is a planar realization of a coil (such as a printed circuit generated coil). In this latter case, the printed circuit can use several layers of conductors as coil windings. In certain embodiments, the field detectors 122 may represent small loops of wire or coils through which a signal is generated in response to a detected alternating current (AC) magnetic field. For example, the field detectors 122 may be co-located in accordance with the industry-standard coil architecture (ISCA). In one embodiment, the field detectors 122 may include one or more MEMS based current and magnetic field sensors.

FIG. 1 further illustrates an analyzer 130 communicatively coupled to the field detectors 122. The field detectors 122 may be coupled to the analyzer 130 through wired or wireless connections. In one embodiment, the analyzer 130 determines a location of the electromagnetic navigation probe 100 within three-dimensional space based at least in part upon the magnetic field detected by field detectors 122. In one embodiment, the electromagnetic navigation probe 100 may generate a time-variant magnetic dipole. Since the magnetic field magnitude and vector quantities (both the DC as well as the AC components), as detected by the field detectors 122, are a function of the dipole location and orientation, the analyzer 130 may solve known equations to determine the location and orientation of the dipole. Additional information on determining a dipole location and orientation can be found in [1] H. P. Kalmus, “A new guiding and tracking system,” IRE Trans. Aerosp. Navig. Electron., vol. 9, pp. 7-10, 1962; [2] F. E. Raab et al., “Magnetic position and orientation tracking system,” IEEE Trans. Aerosp. Electron. Syst., vol. 5, pp. 709-717, 1979; and [3] E. Paperno, et al, IEEE transactions on Magnetics, VOL. 37, NO. 4, July 2001, pp. 1938-1940. In the present application, the dipole's position is determined by relating its coordinates r, θ, and ψ to the measured magnetic quantities such as the AC component of the magnetic field, its extreme values or its phase. The dipole's orientation angles α, β, and γ are similarly determined from the ratio of the extreme values of the magnetic field H, and the AC component. This results in the determination of the location to at least 5 degrees of freedom.

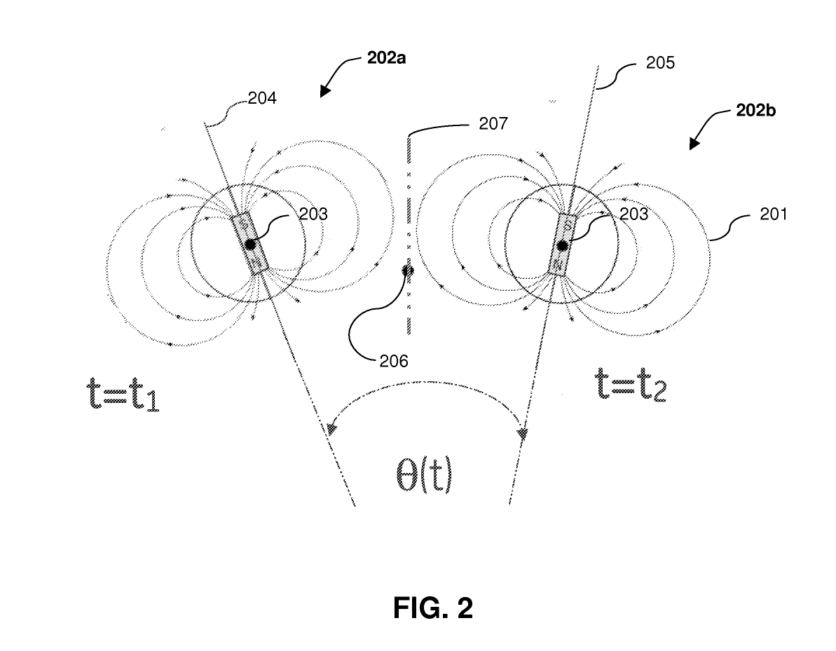

FIG. 2 is a schematic diagram illustrating a magnetic dipole 202a oriented in space along the direction 204. When the dipole is actuated to rotate in a plane about the point 203 by an angle θ, the magnetic field detected at some arbitrary point 206 rotates in space as a result of the time varying angle θ=θ(t), and in particular with respect to an arbitrary direction 207. The rotated dipole (denoted by 202b) is then oriented in space along the direction 205. In the illustrated embodiment of FIG. 2, the dipole is shown to rotate about point 203 which is located between the two poles of the dipole. Although not specifically illustrated, the dipole may instead be configured to rotate by an angle θ about one of the poles (N, S) of the dipole. It should be noted that as a result of the actuation disclosed herein, the dipole can be rotated and moved in space. When such actuation is periodic in nature, an oscillating dipole can be obtained.

In one embodiment, the analyzer 130 of FIG. 1 may be implemented, at least in part, through machine executable instructions in the form of one or more software routines for example. The machine executable instructions may be stored locally or could be received from a remote storage device. Regardless of source, the machine executable instructions may be stored into a temporary memory and accessed and executed using one or more processors of a general purpose computer. In other embodiments, the analyzer 130 may be implemented in discrete hardware or firmware. For example, one or more application specific integrated circuits (ASICs) could be programmed to perform one or more of the above-described analyzer functions. In another example, one or more analyzer functions could be implemented in one or more ASICs, field programmable gate arrays (FPGAs), or static programmable gate arrays (SPGA).

In one embodiment, once the location of the electromagnetic navigation probe 100 has been determined within the area of interest 105, the probe location may be displayed on an electronic display device 140 to facilitate optical navigation e.g. of a surgical procedure. The display device 140 may represent a special purpose display device or may be part of a general-purpose computing system equipped with a video display. Both the analyzer 130 and the display 140 may be part of a shared computing system. In one embodiment, the determined location of the electromagnetic navigation probe 100 may be superimposed upon or otherwise displayed in association with a previously or simultaneously obtained image of the area of interest so as to provide a medical practitioner with real-time visual feedback of the surgery or navigation being performed. For example, the electromagnetic navigation system 120 of FIG. 1 may be used in conjunction with fluoroscopy systems, computed tomography (CT) systems, ultrasound systems, magnetic resonance (MR) imaging systems, or in combination with other imaging systems (such as X-ray) that can benefit from the monitoring of the position of the surgical or procedural tools during surgical or other medical operations.

FIG. 3 illustrates one embodiment of the electromagnetic navigation probe 100. As depicted in the illustrated embodiment, the electromagnetic navigation probe 100 may include a handle end 301 and a tip end 302, wherein the tip end 302 may further include a MEMS device 303 as described in further detail herein. In one embodiment, the MEMS device may operate to generate a time-variant magnetic field at the probe location. It should be noted that the MEMS device 303 has been greatly enlarged in FIG. 3 for the purpose of illustration. As described with respect to FIG. 1, the electromagnetic navigation probe 100 may be used by e.g., a surgeon as part of a larger electromagnetic navigation system. Moreover, due to the very small size of the MEMS device 303, the magnetic field generated by the device can be made to emanate from the tip of the probe, thereby providing a more accurate indication of the probe location and orientation. Although a particular probe structure and form factor is illustrated in FIG. 3, it should be understood that the teachings of the present disclosure are equally applicable to other probe structures and devices known or to be developed.

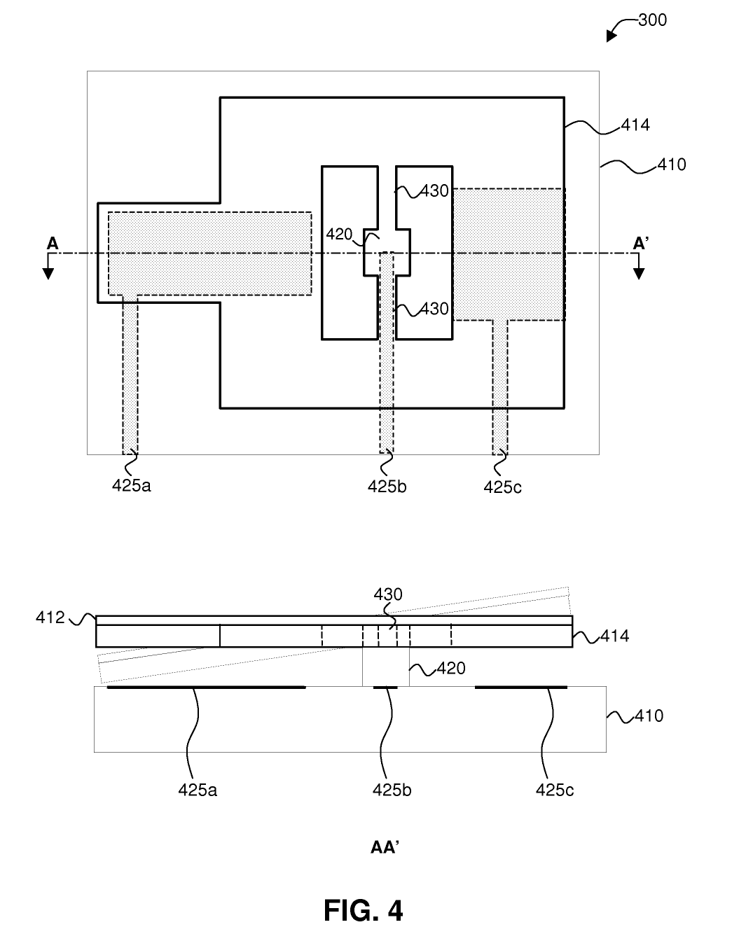

FIG. 4 is a schematic diagram illustrating a top-view and a side view of one embodiment of a MEMS device 300 configured to generate a magnetic field in connection with the electromagnetic navigation probe 100 of FIG. 1 and FIG. 3. In the illustrated embodiment, the MEMS device 300 includes a structural component 410, an actuator 414 and a magnetic field generator 412. The structural component 410 may provide structural support to the actuator 414 and the magnetic field generator 412, and may represent one or more heterogeneous or homogeneous structures, devices, materials, assemblies, sub-systems, elements and so forth. In one embodiment, the structural component 410 may be a silicon substrate.

In the illustrated embodiment of FIG. 4, the magnetic field generator 412 functions to generate or emit a magnetic field. The magnetic field generator 412 may represent any device, component, material or combination of materials that act to generate or emit a magnetic field. For example, in one embodiment, the magnetic field generator 412 may be a current carrying conductor which creates a magnetic field in accordance with Ampère's law. In FIG. 4, the magnetic field generator 412 is shown as one or more regions or layers of one or more ferromagnetic materials. In one embodiment, the magnetic field generator 412 may comprise a soft magnetic material whereas in another embodiment, the magnetic field generator 412 may comprise a hard magnetic material. Examples of soft magnetic materials include materials containing nickel, iron, or cobalt and alloys and subcombinations thereof including but not limited to nickel-iron and nickel-iron-cobalt. Examples of hard magnetic materials include materials containing neodymium-iron-boron (e.g., NdFeB), Samarium Cobalt (e.g., SmCo), Alnico (comprised primarily of aluminum, nickel, cobalt, copper, and iron), CoPt, FePt, or Co-based alloys with P, As, Sb, Bi, W, Cr, Mo, Pd, Pt, Ni, Fe, Cu, Mn, O and H.

In one embodiment, the actuator 414 represents a portion of the MEMS device 300 designed to cause a change in magnetic flux of the magnetic field generated by the magnetic field generator 412. The actuator 414 may represent a mechanical, an electrical, an electromechanical, or an optical device or component that is integral to or in operative association with the MEMS device 300. In various embodiments, the actuator 414 may be formed from a portion of the substrate 410. For example, in certain embodiments, the actuator 414 may represent a cantilever or beam that is released from the substrate 410 (e.g., on three sides) such that the actuator is deflectable about a single anchor point. In the event the anchor point comprises a pedestal located between the ends of the cantilever (as illustrated in FIG. 4), the actuator may deflect with a see-saw type motion. Similarly, the actuator 414 may represent a membrane or diaphragm structure that is attached to the substrate 410 (e.g., on at least three sides) such that a center portion of the actuator is deflectable. In the cantilever and diaphragm embodiments of the actuator, a single force is typically imparted upon the actuator which causes it to deflect in a single plane. In accordance with the illustrated embodiment of FIG. 4, the actuator 414 may be a torsional element that deflects in more than one plane.

In FIG. 4, the actuator 414 includes a torsional member 430 which experiences a bending force and a twisting force (or torsion) upon actuation. As shown, the actuator 414 and torsional member 430 are separated from the substrate 410 by a pedestal 420. As such, the actuator 414 may deflect in a seesaw fashion (as shown in phantom) while the torsional member 430 experiences a twisting force.

In one embodiment, MEMS 300 may further include a number of contact pads to facilitate actuation of the actuator 414. In the illustrated embodiment, contact pads 425a, 425b and 425c are disposed between the actuator 414 and the substrate 415. As shown, the contact pads are disposed on a top surface of the substrate 415 and on both sides of the pedestal 420. In other embodiments, the contact pads may be located on a surface of the substrate 415 and a surface of the actuator 414, located on a single side of the pedestal 420 or both sides of the pedestal, or variations thereof.

The contact pads may facilitate actuation of the actuator 414 through generation of an attracting or repelling force. For example, the electrodes 425b and 425c may be grounded while a potential is applied the electrode 425a. This creates an attractive force between the electrode 425a and the actuator 414, causing the actuator 414 to deflect as illustrated. During the next phase of the oscillation, the same potential may be applied to electrode 425c while electrode 425b is grounded. This creates an attractive force between 425c and actuator 414, causing the actuator 414 to deflect in the opposite direction. In one embodiment, the actuator 414 may be electrostatically actuated, whereas in another embodiment, the actuator 414 may be electromagnetically actuated or mechanically actuated through e.g., piezo-electric actuation. In yet further embodiments, the actuator 414 may be optically or thermally actuated. In one embodiment, two materials of different coefficients of thermal expansion may be heated either by resistive heating or by a laser radiation. The resulting asymmetrical expansion results in the movement of an analogous plate and causes actuation.

In the MEMS device 300, actuation of the actuator 414 causes magnetic field generator 412 to move or rotate about pedestal 420. In so doing, a time-variant magnetic dipole having a center fixed in space is formed. In one embodiment, the dipole may oscillate about the fixed center at a relatively low frequency such as a frequency lower than 400 hz, which significantly reduces the strength of eddy currents produced by nearby field-distorting electrically-conductive materials. In one embodiment, the dipole may oscillate at frequencies below that of the AC electrical power supplied by power utilities, typically 50-60 Hz as the magnetic fields and low harmonics of the utility power can distort measurements. More particularly, the low frequency may be below 60 Hz. More particularly still, the low frequency may be approximately 25 Hz. At approximately 25 Hz, distortion-free measurements may be made in the presence of distorters with relatively large skin depths such as 0.66 inch or larger. In one specific embodiment, the magnetic field generator 412 may comprise neodymium-iron-boron that when exposed to a magnetic field of approximately 20-25 nT causes approximately a 20 μm displacement in the actuator 414 resulting in a magnetic dipole moment of at least 2*10⁻² μm².

In accordance with one embodiment, the MEMS device 300 of FIG. 4 may be fabricated using techniques generally used for the fabrication of MEMS devices including photolithographic techniques. These techniques are however modified to accommodate magnetic materials such as those used to form the magnetic field generator 412. In one embodiment, the magnetic field generator 412 may be obtained by adding the formation of a film of hard or soft magnetic materials. In particular, deposition of Nd—Fe—B thin film may be used to form magnetic field generator 412. For example, fabrication of the MEMS device 300 may start with a silicon substrate and use aKrF excimer pulse laser (λ248 nm) on targets made of Nd2Fe14B to form a film on a Si (100) substrate. In another example, electroplating magnetic films along with silicon-based surface micromachining may be used to fabricate these devices. In particular, either frame-plating techniques or one-mask plating processes are used to electrodeposit NiFe onto polysilicon flexures coated with Cr—Cu seed layers. The (micro)actuators may then be released by removing an underlying sacrificial layer in a hydrofluoric-acid etch, for example. Additive patterning processes of magnetic films are grown using an ion-beam sputter (IBS) system designed to produce non-conformal films. In another embodiment, ion-beam sputtering is used to obtain the magnetic thin films. One can thusly obtain Ni80Fe20 and Co70Fe30 magnetic thin films as the magnetic field generator 412. In general, various hard magnetic materials can be prepared by vacuum processes (e.g., evaporation, sputtering, molecular beam epitaxy, chemical vapor deposition), and electrochemical processes (e.g., electroless deposition and electrodeposition), in addition to the metallurgical processes (e.g., sintering, pressure bonding, injection molding, casting, extruding, and calendering).

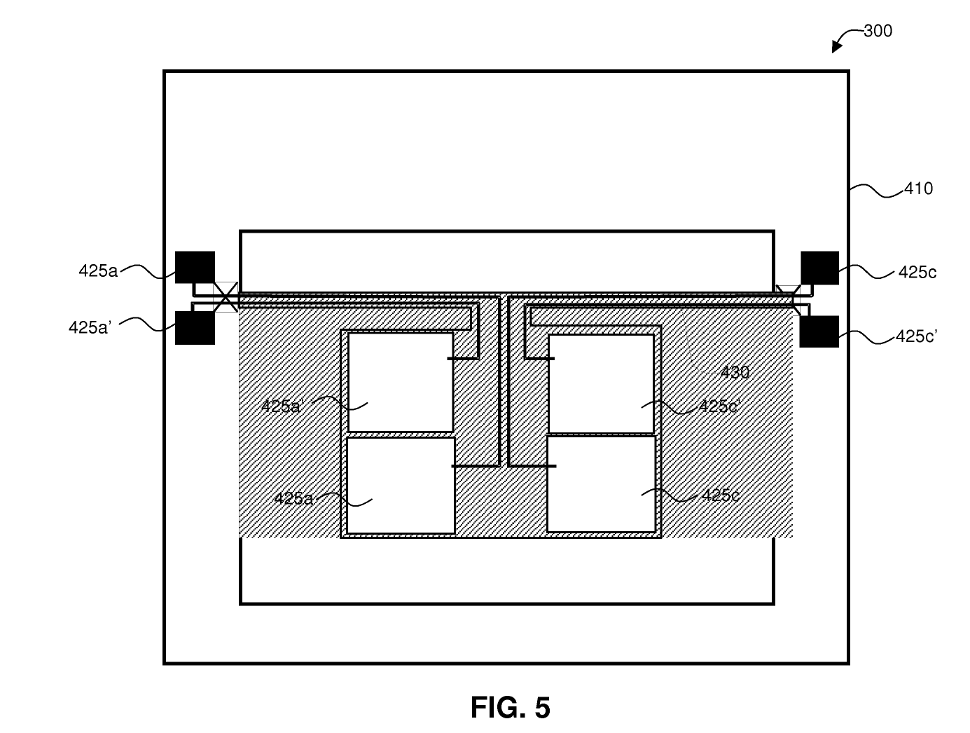

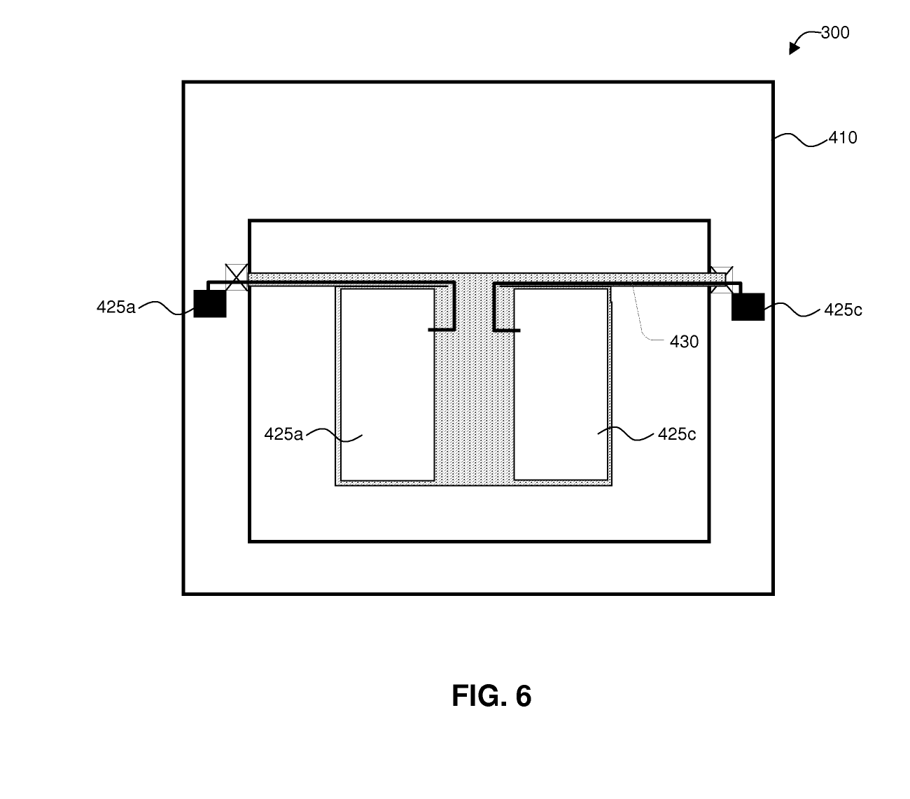

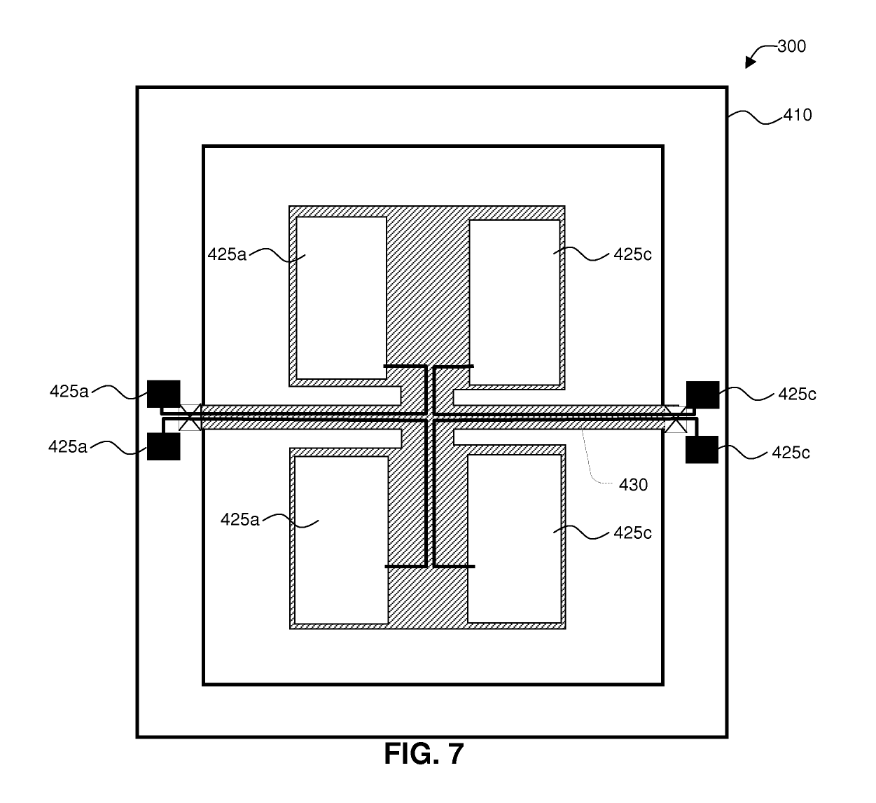

FIGS. 5-7 are schematic diagrams each illustrating alternative embodiments of a MEMS device 300 configured to generate a magnetic field in connection with the electromagnetic navigation probe 100 of FIG. 1 and FIG. 3. As with the MEMS device of FIG. 4, each of FIGS. 5-7 illustrate torsional MEMS devices that include a structural component 410, an actuator 414, a magnetic field generator 412, a torsional member 430, and contact pads 425a, 425a′, 425c and 425c′. Each of the components illustrated in FIGS. 5-7 function in a substantially similar manner to those illustrated in FIG. 4.

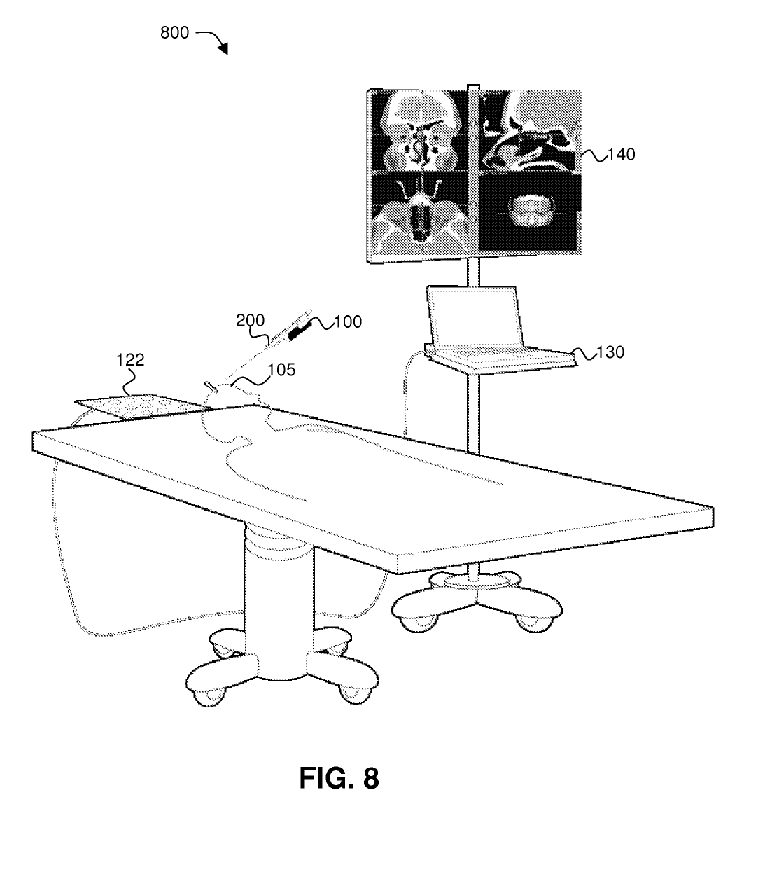

FIG. 8 is a schematic diagram illustrating an example application 800 of the electromagnetic navigation system 120 described herein. In the illustrated embodiment, the electromagnetic navigation probe 100, including MEMS device 300, is utilized in conjunction with a surgical procedure where the location of the probe within an area of interest 105 is displayed on display device 140. As previously described, the electromagnetic navigation probe 100 generates a magnetic field which is detected by field sensors 122. In the illustrated embodiment, field sensors 122 are depicted as an array of sensors configured to be placed near the area of interest 105, such as under a patient's head in the case of brain surgery. Analyzer 130 represents a computing device equipped to determine the precise location of the electromagnetic navigation probe 100 within the area of interest 105 and superimpose the location on the display device 140 in association with a previously or concurrently obtained image of the area of interest.

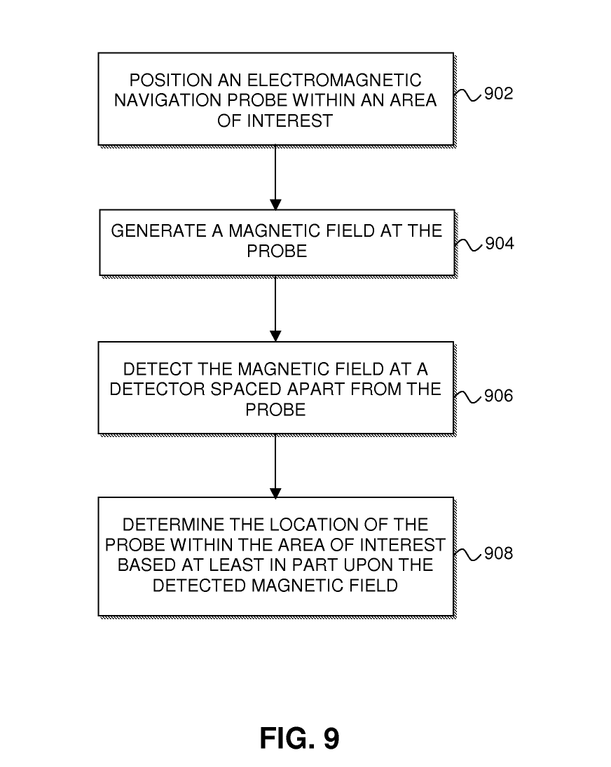

FIG. 9 is a block diagram illustrating an example operational flow for a method of determining a location of an electromagnetic navigation probe within an electromagnetic navigation system such as that illustrated in FIG. 8. As shown, the method includes positioning the electromagnetic navigation probe within the area of interest (block 802) and generating a magnetic field at the location of the probe (block 804). Subsequently, the magnetic field is detected at a detector spaced apart from the probe (block 806) and the location of the probe within the area of interest is determined based at least in part upon the detected magnetic field. (block 808).

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An electromagnetic navigation probe comprising:
a structural component;
a magnetic field generator coupled to the structural component for generating a magnetic field; and
an actuator for varying the magnetic field as a function of time and space such that a location of the probe in three dimensional space can be determined.

2. The electromagnetic navigation probe of claim 1, wherein the location is determined to at least 5 degrees of freedom.

3. The electromagnetic navigation probe of claim 1, wherein the magnetic field generator generates an oscillating magnetic field.

4. The electromagnetic navigation probe of claim 1, wherein the magnetic field generator generates a magnetic dipole.

5. The electromagnetic navigation probe of claim 4, wherein the magnetic dipole has a center fixed in space and the dipole is rotatable about fixed center to obtain a time-variant magnetic field.

6. The electromagnetic navigation probe of claim 5, wherein an angle of the magnetic field with respect to a reference direction varies.

7. The electromagnetic navigation probe of claim 4, wherein the magnetic field generator comprises neodymium-ion-boron.

8. The electromagnetic navigation probe of claim 4, wherein the magnetic dipole comprises a dipole moment of at least 2*10⁻² μm².

9. The electromagnetic navigation probe of claim 1, wherein the probe comprises a micro electromechanical system.

10. The electromagnetic navigation probe of claim 9, wherein the actuator comprises a cantilever.

11. The electromagnetic navigation probe of claim 10, wherein the actuator is configured for electrostatic or electromagnetic or piezo-electric actuation.

12. The electromagnetic navigation probe of claim 10, wherein the actuator is configured for optical or thermal actuation.

13. The electromagnetic navigation probe of claim 9, wherein the actuator comprises a torsional member.

14. The electromagnetic navigation probe of claim 13, wherein the actuator is configured for electrostatic or electromagnetic actuation.

15. The electromagnetic navigation probe of claim 13, wherein the actuator is configured for optical or thermal actuation.

16. The electromagnetic navigation probe of claim 9, wherein the actuator comprises a membrane.

17. The electromagnetic navigation probe of claim 16, wherein the actuator is configured for electrostatic or electromagnetic actuation.

18. The electromagnetic navigation probe of claim 16, wherein the actuator is configured for thermal or optical actuation.

19. The electromagnetic navigation probe of claim 9, wherein the probe comprises a ferromagnetic material for generating a magnetic dipole and varying the magnetic dipole based at least in part upon actuation of the micro electromechanical system.

20. The electromagnetic navigation probe of claim 9, wherein the structural component supports the actuator and the magnetic field generator.

21. The electromagnetic navigation probe of claim 9, wherein the magnetic field generator comprises a conductor for carrying an electric current

22. The electromagnetic navigation probe of claim 9, wherein the magnetic field generator comprises a ferromagnetic material.

23. The electromagnetic navigation probe of claim 22, wherein the ferromagnetic material comprises a soft magnetic material.

24. The electromagnetic navigation probe of claim 23, wherein the ferromagnetic material comprises nickel-iron alloys.

25. The electromagnetic navigation probe of claim 23, wherein the ferromagnetic material comprises nickel, iron, cobalt or a combination thereof.

26. The electromagnetic navigation probe of claim 22, wherein the ferromagnetic material is a hard magnetic material.

27. The electromagnetic navigation probe of claim 22, wherein the ferromagnetic material comprises neodymium-iron-boron.

28. The electromagnetic navigation probe of claim 1, further comprising:
a handle end and a tip end, wherein the tip end comprises a micro electromechanical system including the structural component, the magnetic field generator and the actuator.

29. The electromagnetic navigation probe of claim 1, further comprising a controller to provide oscillatory actuation of the actuator.

30. An electromagnetic navigation system comprising:
a electromagnetic navigation probe for performing a procedure within an area of interest, the probe comprising a magnetic field generator and an actuator to induce a change in magnetic flux in a magnetic field generated by the magnetic field generator;
a plurality of detectors spaced away from the probe to detect the magnetic field generated by the probe; and
an analyzer to determine a location of the probe within three-dimensional space based at least in part upon the magnetic field.

31. The electromagnetic navigation system of claim 30, wherein the plurality of detectors comprises at least one micro electromechanical system based current sensor.

32. The electromagnetic system of claim 30, wherein the electromagnetic navigation probe comprises a micro electromechanical system.

33. The electromagnetic navigation system of claim 30, further comprising a controller to provide oscillatory actuation of the actuator.

34. The electromagnetic navigation system of claim 33, wherein the controller provides oscillatory actuation at a frequency less than 400 hz.

35. A method comprising:
positioning an electromagnetic navigation probe within an area of interest;
generating a magnetic field at the probe;
detecting the magnetic field at a detector spaced apart from the probe; and
determining the location of the probe within the area of interest based at least in part upon the detected magnetic field.

36. The method of claim 35, further comprising:
determining and orientation of the probe within the area of interest; and
graphically displaying the probe at the determined location with the orientation.

37. The method of claim 35, further comprising varying the magnetic field as a function of time and space.

38. The method of claim 37, wherein varying the magnetic field as a function of time and space comprises actuating the micro electromechanical system.

39. The method of claim 37, wherein varying the magnetic field as a function of time and space comprises actuating the micro electromechanical system to generate a magnetic dipole.
